(19) United States
(12) Patent Application Publication
(10) Pub. No.: US 2009/0046115 A1
(43) Pub. Date: Feb. 19, 2009

(54) Method and System to Change Printed Document Based on Printer Ink Levels

(75) Inventors: Lisa Anne Seacat, San Francisco, CA (US); Robert Peterson, Austin, TX (US); Kulvir S. Bhogal, Fort Worth, TX (US)

Correspondence Address: IBM ST-SVL;SAWYER LAW GROUP LLP, 2465 E. Bayshore Road, Suite No. 406, PALO ALTO, CA, 94303, US

(73) Assignee: International Business Machines Corporation, Armonk, NY (US)

(21) Appl. No.: 11/838,150

(22) Filed: Aug. 13, 2007

(51) Int. Cl. H04N 1/034; B41J 2/195

(52) U.S. Cl. 347/3; 347/7

(57) ABSTRACT

A method and system in accordance with the present invention modifies a document or a section of a document to be printed, based on available ink levels in a printer. The modification process may be carried out automatically, or may be user-selected and defined, in order to maximize the quality of the printer output.

### FIELD OF THE INVENTION

The present invention relates generally to printers and more specifically to changing a printed document based on printer ink levels.

### BACKGROUND OF THE INVENTION

Sometimes, when a user is printing a document on a color printer, one of the printer ink cartridges in the printer will be found to be low in ink supply. The user is then faced with either going ahead and printing the document, with one or more colors appearing at a poor quality level, or waiting until the ink cartridge can be replaced.

The ability for a computer to communicate with a printer and to obtain printer information such as ink and paper levels is well known. There also exist conventional means to optimize the output of a printer.

What is needed is the ability to modify a section of a document to be printed so that a printer will achieve maximum utilization of its various ink cartridges based on available ink levels, resulting in the highest possible print quality without having to delay printing while one or more replacement ink cartridges are obtained. The present invention meets such a need.

### SUMMARY OF THE INVENTION

A method and system for changing a printed document based upon print cartridge ink levels in a printer system is disclosed. The printing system comprises a processor coupled to a printer. The method and system comprise determining the ink levels of each of a plurality of print cartridges in a printer by the print driver in the processor; and determining that the ink level of at least one of the plurality of ink cartridges is in low supply of ink. The method and system includes receiving a document in the printer; and analyzing the requirements for printing the document to determine if the document requires ink from the ink cartridge which is in the printer which is low in ink supply. Finally, the method and system includes modifying the requirements for printing the document such that the dependency on the ink cartridge in low supply is reduced if the document requires ink from the ink cartridge in low supply.

### BRIEF DESCRIPTION OF THE DRAWINGS

FIG. 1 is a block diagram which shows a processor coupled to a printer.

FIG. 2 is a flow chart of a method to change a printed document in accordance with the present invention.

FIG. 3 illustrates a pie chart and the relative levels of ink supply in the printer as a 3D bar graph.

FIG. 4 illustrates the yellow portion of the pie chart that has a low ink evaluation.

### DETAILED DESCRIPTION

The present invention relates generally to printers and more specifically to printer ink levels/printer output quality. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

A method and system in accordance with the present invention modifies a document or a section of a document to be printed, based on available ink levels in a printer. The modification process may be carried out automatically, or may be user-selected and defined, in order to maximize the quality of the printer output.

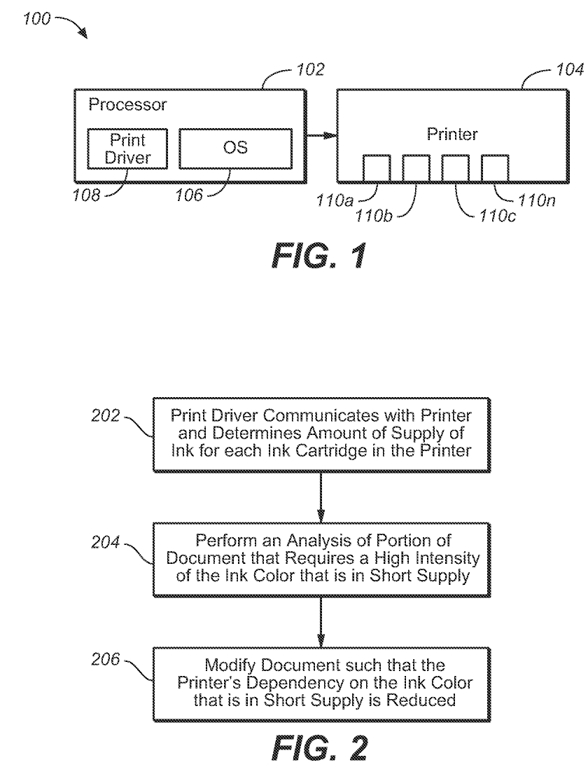

FIG. 1 is a block diagram of a processor 102 coupled to a printer 104 to provide a printing system 100. The processor 102 includes an operating system 106 and a print driver 108. The printer 104 includes a plurality of ink cartridges 110a-n. Although the figure shows a processor 102 and a printer 104 connected together directly, the print commands could be issued from a remote processor via a network, for example (not shown).

The method and system in accordance with the present invention enhances printing systems by modifying the document to be printed so that the need to utilize one or more ink cartridges 110a-110n which may be low in ink quantity is lessened or removed completely. For example, a user may need, for example, to print a PowerPoint™ presentation and then discover that the printer 104 is low on a particular color of ink. When the document is sent to the print driver 108 of the processor 102 to be printed, the print driver 108 first interacts with the printer 104 and determines that the printer 104 has a low supply of yellow ink. The print driver 108 then modifies the portion of the document with other colors or patterns so that the need to utilize that particular color of ink in printing the document is reduced. This dynamic modification may occur automatically or may occur only after the user has defined and selected the nature of the document modification. A provision may also be added to be able to set predetermined policies, such as “always change yellow to blue”.

FIG. 2 is a flow chart of a method to change a printed document in accordance with the present invention.

Referring to FIGS. 1 and 2 together, first the print driver 108 of the processor 102 communicates with the printer 104 and determines the ink level supply for each ink cartridge 110a-110n in the printer 104, via step 202.

Then, when the print driver 108 receives a document to be printed, it performs an analysis of portion of the document that requires a high intensity of the ink color that is in short supply, via step 204. The document is then modified such that the printer's dependency on the ink color in short supply is reduced, via step 206.

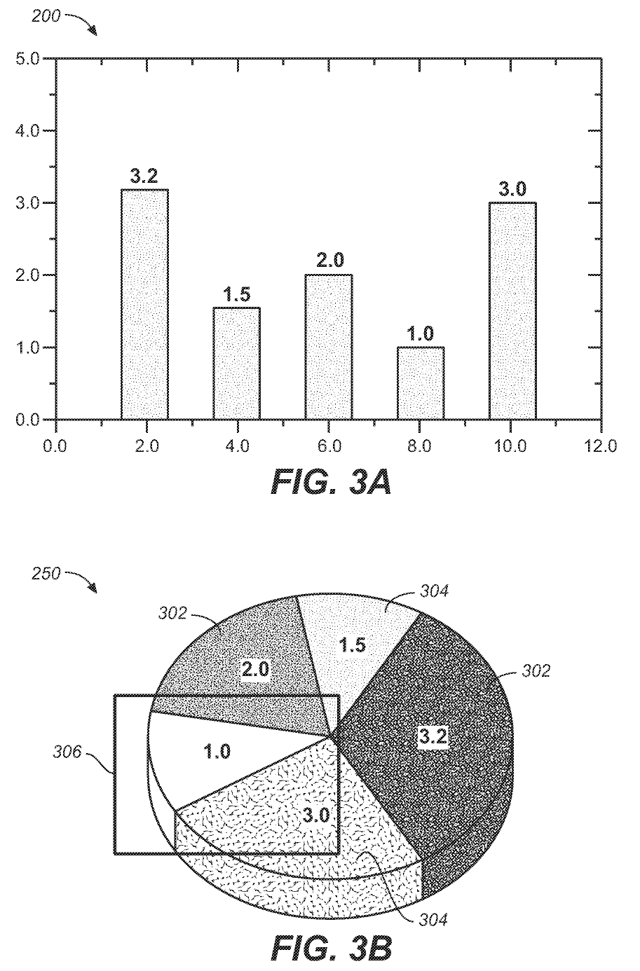

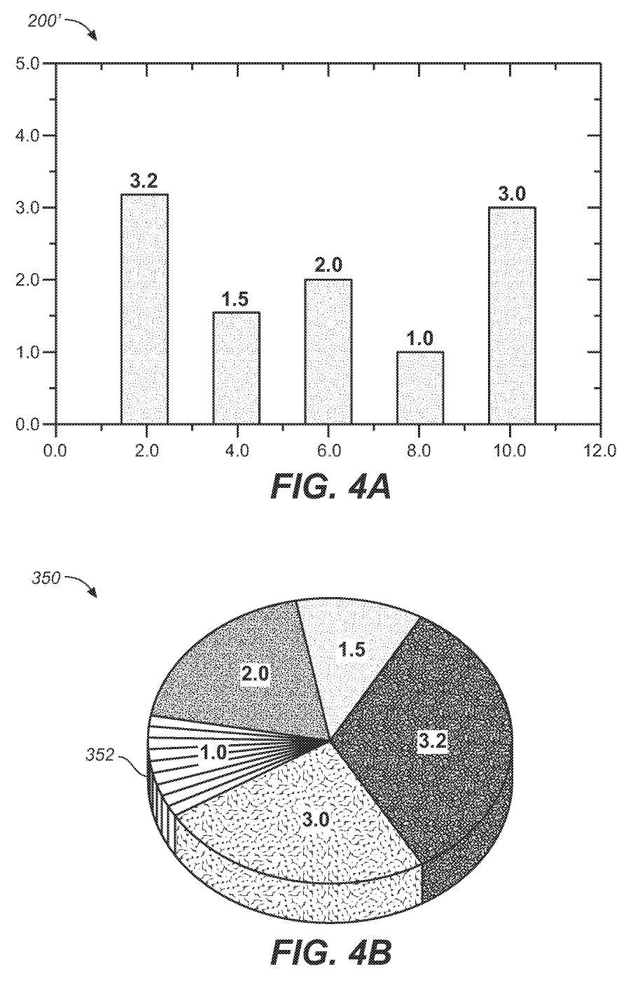

FIG. 3 illustrates a pie chart 250 and the relative levels of ink supply in the printer 104 as a 3D bar graph 200. The 3D bar graph 200 indicates the ink level of a plurality of colors, namely blue 302, green 304, turquoise 306, yellow 308 and light green 310, that are identified in the pie chart 250. As is seen in bar chart 200, the ink level of yellow 306 is at an unacceptably low level. Accordingly, FIG. 4 illustrates the yellow portion of the pie chart 350 has been replaced with a gray striped pattern 352 due to the low ink level of the yellow ink cartridge 308 shown in bar chart 200.

Although the above-cited example describes a computer program/application Microsoft PowerPoint™, the method and system in accordance with the present invention could be utilized with one or a plurality of different kinds and versions of software or operating systems.

A method and system in accordance with the present invention modifies a document or a section of a document to be printed, based on available ink levels in a printer. The modification process may be carried out automatically, or may be user-selected and defined, in order to maximize the quality of the printer output.

In one instance, the user would benefit from this communication process because they would be able to replace the effect of poor print quality resulting from an ink supply deficiency.

In another instance, it might be that certain colors or kinds of ink are expensive. The user might want to print certain colors in black and white, shades of gray, or gray patterning.

In another embodiment of the process in accordance with the present invention, the printer notifies the operating system when an ink cartridge is low and all other documents after that point are printed at a lower quality automatically.

In one embodiment, in order to improve print quality, the method and system in accordance with the present invention inserts metadata in a document that is to be printed. The metadata defines which sections of a document, or an entire document, include areas which require color printing in the color or colors which are low in the printer.

The metadata could be included within software, such as Microsoft Power Point. Such metadata might instruct the printer to replace a certain color which is running low globally with another solid color, or perhaps a striped or polka-dot pattern. FIG. 2, referred to above, is a good example of this process.

In a second embodiment, the original author of a document could highlight or select certain areas of a document, and then define the metadata in such a way that these would be printed in a different color or pattern if the predominant ink color in the selected document sections is low in the printer. The author's modifications would not be able to be changed by a user.

In a third embodiment, the user printing the document could define the metadata to make such ink and pattern substitutions.

In a fourth embodiment, the user could define such metadata globally for one or more software applications on their computer. In such instances, when then using a particular application, the user would be able to choose whether or not to see locations where the metadata rules are applied within that particular application, by right clicking a selection “Show metadata options.”

In a fifth embodiment, such metadata could be embodied within an operating system, so as to affect all documents printed when that operating system is being utilized.

In a sixth embodiment, the metadata and software could be located within the printer.

Accordingly, utilizing a system and method in accordance with the present invention, a first goal is to be able to maintain a high print appearance quality.

Furthermore, a second goal is to modify the printing of the document to serve other purposes, such as highlighting certain kinds or sections of charts or graphs, or to serve physical disabilities such as color blindness.

The modification process allows for a number of different kinds of choices: based, for example, either on color substitutions or on pattern substitutions.

In an embodiment, once it has been determined that a desired printed color in a section of the document requires a greater percentage of the ink which is low in supply than may be available to produce the desired color, a different color of ink is substituted and/or a patterned area is printed in place of the original desired color.

### Ink Color Substitutions

The process involving ink color substitutions comprises the steps of (1) determining ink levels, (2) modifying the document based on the ink levels or defining metadata which instructs the computer to perform the requested modifications on the printed document.

### Patterning Substitutions

The process involving patterning substitutions comprises the steps of (1) determining the ink levels, and (2) determining the type of image to be modified (polka-dot pattern, striped pattern) or defining the metadata for the section or globally which determines modifications for a particular kind of pattern (i.e., all striped patterns might be printed in a certain shading of gray).

The original document will not be changed by either an ink substitution process or a patterning substitution process. However, if the user wishes to do so, they may save a second version of the document which incorporates the metadata instructions.

A color-blind person, for example, could instruct the printer to modify a document or sections of a document so that the document would be printed only in colors that the user could see.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for changing a printed document based upon print cartridge ink levels in a printer system, the printing system comprising a processor coupled to a printer; the method comprising:
determining the ink levels of each of a plurality of print cartridges in a printer by the print driver in the processor;
determining that the ink level of at least one of the plurality of ink cartridges is in low supply of ink;
receiving a document in the printer;
analyzing the requirements for printing the document to determine if the document requires ink from the ink cartridge which is in the printer which is determined not to be utilized; and
modifying the requirements for printing the document such that the dependency on the ink cartridge not to be utilized is reduced if the document requires ink from the ink cartridge not to be utilized.

2. The method of claim 1 wherein modifying the document comprises:
substituting an ink color from a different ink cartridge for the print cartridge that has a low supply of ink.

3. The method of claim 1 wherein modifying the document comprises substituting a patterned image for the ink color of the ink cartridge in low supply.

4. The method of claim 1 wherein modifying the document comprises defining which sections that include areas which require color printing in the color or colors which are low in the printer, instructs the printer to replace a certain color globally when the ink level of the print cartridge is below a predetermined amount.

5. The method of claim 1 modifying the document comprises defining the sections of the document that include areas which require printing in the color or colors that are low in the printer.

6. The method of claim 4 wherein an original author defines the sections that include areas which require printing in the colors that are low in the printer.

7. The method of claim 4 wherein the color is globally replaced by another color.

8. The method of claim 4 wherein the color is globally replaced by a pattern.

9. A system comprising:
a processor, the processor including an operating system; and
a printer coupled to the operating system, the printer including a plurality of ink cartridges and a mechanism for a printed document based upon print cartridge levels in the printer, the mechanism comprising determining the ink levels of each of a plurality of print cartridges in a printer by the print driver in the processor; determining that the ink level of at least one of the plurality of ink cartridges is in low supply of ink; receiving a document in the printer; analyzing the requirements for printing the document to determine if the document requires ink from the ink cartridge which is in the printer which is determined not to be utilized; modifying the requirements for printing the document such that the dependency on the ink cartridge not to be utilized is reduced if the document requires ink from the ink cartridge in low supply.

10. The system of claim 9 wherein modifying the document comprises substituting an ink color from a different ink cartridge for the print cartridge that has a low supply of ink.

11. The system of claim 9 wherein modifying comprises substituting a patterned image for the ink color of the ink cartridge in low supply.

12. The system of claim 9 wherein modifying the document comprises defining which sections that include areas which require color printing in the color or colors which are low in the printer, instructs the printer to replace a certain color globally when the ink level of the print cartridge is below a predetermined amount.

13. The system of claim 9 wherein modification define the sections of the document that include areas which require printing in the color or colors that are low in the printer.

14. The system of claim 12 wherein the original author defines the sections that include areas which require printing in the colors that are low in the printer.

15. The system of claim 12 wherein the color is globally replaced by another color.

16. The system of claim 12 wherein the color is globally replaced by a pattern.

17. The system of claim 12 wherein the operating system defines the sections printing in the colors that are low in the printer.

18. The system of claim 17 wherein information about replacement of color is performed by a preference file in the operating system.

19. The system of claim 12 wherein some colors are replaced regardless of ink levels based upon a user preference.

20. The system of claim 12 wherein the system alerts the user that a color is running low and highlights the trouble areas, wherein a user interface is utilized to indicate which of the available colors should be used.
